(19) United States
(12) Patent Application Publication
(10) Pub. No.: US 2015/0360431 A1
(43) Pub. Date: Dec. 17, 2015

(54) BULK BAG CONDITIONER WITH VERTICALLY TRAVELING RAM ASSEMBLIES

(71) Applicant: Flexicon Corporation, Bethlehem, PA (US)

(72) Inventors: Daniel Halvorsen, Sandwich (GB); Keith Bourton, Whitstable (GB)

(73) Assignee: Flexicon Corporation, Bethlehem, PA (US)

(21) Appl. No.: 14/737,618

(22) Filed: Jun. 12, 2015

Related U.S. Application Data
(60) Provisional application No. 62/011,113, filed on Jun. 12, 2014.

(51) Int. Cl. B30B 12/00; B30B 15/04

(52) U.S. Cl. CPC B30B 12/00; B30B 15/04

(57) ABSTRACT

An apparatus for conditioning a bulk bag and a compacted product contained within the bag is provided to facilitate emptying the contents of the bag. A frame encloses a bulk bag receiving region including a support surface for receiving the bulk bag for conditioning. A plurality of conditioning plates, supported for horizontal and vertical displacement, is provided to break up the compacted product within the bag.

### INCORPORATION BY REFERENCE

The following documents are incorporated herein by reference as if fully set forth: U.S. Provisional Application No. 62/011,113, filed Jun. 12, 2014.

### FIELD OF THE INVENTION

The present invention relate to the field of bulk material handling of bulk bags, and more particularly to a bulk bag conditioner.

### BACKGROUND

In some cases, it is desirable to ship or store materials in bulk bags. Bulk bags may be formed from a fabric to have an inlet at the top to allow the bag to be filled and sealed, and outlet at the bottom, closed to hold the product until the bulk bag is to be emptied.

In some cases, particulate materials (i.e., granular or powdered materials) shipped or stored in bulk bags can become compacted over time or under certain environmental conditions, such as heat and humidity, into a solidified mass. Some materials can become compacted to such an extent that a sufficient amount of the contents forms a densified mass which hampers or prevents emptying of the bulk bag when desired. Conditioning of the compacted product within the bag by impacting the bulk bag to break up the densified masses has been known to facilitate emptying of the contents.

Some of the methods that have been devised to break up the dense mass to allow emptying of the contents of a bulk bag include manually impacting the sides of the bag or dropping the bag on a floor to break up the material to allow it to flow out of the bulk bag. Manually impacting the bulk bag has been observed to be inefficient and ineffective, while dropping the bulk bag has been observed to cause the bulk bag to rupture.

Mechanical means for breaking up the contents of bulk bags typically involve a lift for raising and lowering the bulk bag while vertically fixed arms impact the bulk bag. However, vertically lifting some bulk bags requires significant energy requirements to move the bags which may weigh as much as 2,200 pounds. The bags may be 72″ tall or taller, requiring a significant overhead space to move the bags while they are being conditioned by the vertically fixed arms.

Accordingly, a need exists for a bulk bag conditioner that overcomes the drawbacks of current systems.

### SUMMARY

An apparatus and method for conditioning bulk bags are provided herein. In one embodiment, a bulk bag conditioning apparatus comprises a frame including a first side wall and an opposing second side wall enclosing a bulk bag receiving region. A bulk bag support surface is disposed within the bulk bag receiving region, and is preferably in a vertically fixed position with respect to the frame. A first plate is disposed on the first side wall supported for vertical displacement between a first lower position, adjacent to the bulk bag support surface, and a first upper position, spaced upwardly apart from the bulk bag support surface. The first plate is further supported for linear displacement within the receiving region between a first retracted position, adjacent the first side wall, and a first extended position. A second plate is disposed on the second side wall supported for vertical displacement between a second lower position, adjacent to the bulk bag support surface, and a second upper position spaced upwardly apart from the bulk bag support surface. The second plate is further supported for linear displacement within the receiving region between a second retracted position, adjacent the second side wall, and a second extended position.

In other embodiments, a method of conditioning a bulk bag is provided. A bulk bag conditioning apparatus is provided comprising a frame including a first side wall and an opposing second side wall enclosing a bulk bag receiving region, a bulk bag support surface is disposed within the bulk bag receiving region in a vertically fixed position with respect to the frame. A first plate is disposed on the first side wall supported for vertical displacement between a first lower position, adjacent to the bulk bag support surface, and a first upper position, spaced apart from the bulk bag support surface. The first plate is further supported for linear displacement within the receiving region between a first retracted position, adjacent the first side wall, and a first extended position. A second plate is disposed on the second side wall supported for vertical displacement between a second lower position, adjacent to the bulk bag support surface, and a second upper position, spaced apart from the bulk bag support surface. The second plate is further supported for linear displacement within the receiving region between a second retracted position, adjacent the second side wall, and a second extended position.

The method further includes placing a bulk bag to be conditioned in the bulk bag receiving region on the bulk bag support surface; positioning the first plate at the first vertical position, extending the first plate into the bulk bag receiving region, contacting the bulk bag with the first plate, and retracting the first plate; positioning the second plate at a second vertical position, extending the second plate into the bulk bag receiving region, contacting the bulk bag with the second plate, and retracting the second plate; positioning the first plate at a third vertical position, contacting the bulk bag with the first plate by extending the first plate into the bulk bag receiving region, and retracting the first plate; and positioning the second plate at a fourth vertical position, contacting the bulk bag with the second plate by extending the second plate into the bulk bag receiving region and retracting the second plate. Here, the first and second plates can move simultaneously to the respective first and second extended positions, or can be moved alternately. Further, the first and second vertical positions can be the same or different from one another, and the third and fourth vertical positions can also be the same or different from one another.

Other and further embodiments of the present invention are described below.

### BRIEF DESCRIPTION OF THE DRAWINGS

Embodiments of the present invention, briefly summarized above and discussed in greater detail below, can be understood by reference to the illustrative embodiments of the invention depicted in the appended drawings. It is to be noted, however, that the appended drawings illustrate only typical embodiments of this invention and are therefore not to be considered limiting of its scope, for the invention may admit to other equally effective embodiments.

FIG. 1 is a perspective view of a bulk bag conditioning apparatus in accordance with an embodiment of the present invention.

FIG. 2A is an exploded view of a carriage in accordance with an embodiment of the present invention.

FIG. 2B is an assembled perspective view of the carriage of FIG. 2A disposed on a side wall.

FIG. 3 is a partial view of a portion of the apparatus of FIG. 1 taken along line III-III.

FIG. 4 is an enlarged view of the encircled portion IV of FIG. 3.

FIGS. 5A-5F are views of a bulk bag conditioner in various stages of operation in accordance with one preferred method the present invention taken along line V-V of FIG. 1.

FIG. 6 is a flow diagram depicting a method of conditioning a bulk bag in accordance with an embodiment of the present invention.

FIG. 7 is a partial perspective view of a portion of the apparatus of FIG. 1 with an alternate drive for raising and lowering the carriage.

FIG. 8 is an elevational view of the alternate drive of FIG. 7 showing a position sensor for the carriage.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Emptying of products that have become compacted into a solidified mass during storage in bulk bags may be facilitated by embodiments of the present invention disclosed herein. Embodiments may effectively and efficiently break up granular, powdered, or other particulate contents of a bulk bag that have become a compacted mass while contained within the bulk bag.

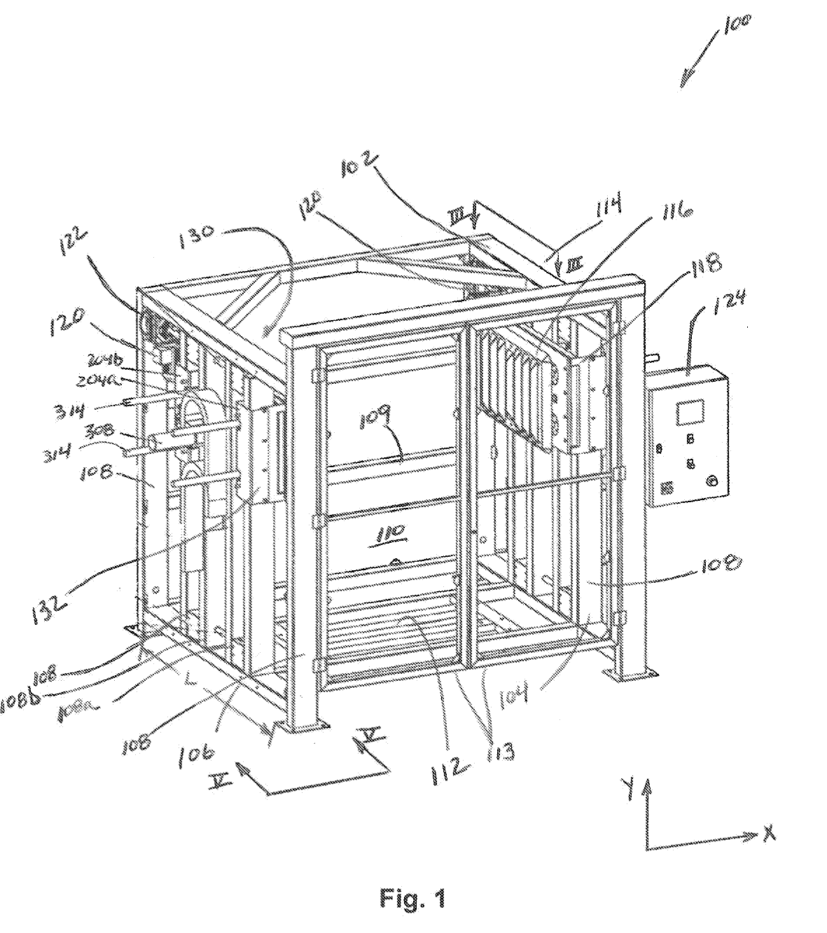

FIG. 1 generally depicts an apparatus 100 for conditioning a bulk bag in accordance with an embodiment of the present invention. The apparatus 100 comprises a frame 102 formed from a first side wall 104, and an opposing second side wall 106, of similar construction. As illustrated, the first and second side walls 104, 106 are generally vertical and parallel and are preferably formed of rectangular tubular members 108. The members 108 are spaced apart from each other with inside and outside faces aligned along the length L of the first and second side walls 104, 106. Safety panels (not shown) of open material (e.g. mesh, perforated, or woven material) or closed material (solid) may extend about and surround either of the side walls to protect users from moving equipment parts.

The non-limiting embodiment of the frame 102 is illustrated as rectangular in shape for ease of illustration only. Additional flat or curved end panels may be applied to the frame 102 between an end of the first side wall 104 and a corresponding end of the second side wall 106. The panels may be open or closed as above, and may be fixed to the frame 102 or movable with respect to the frame.

The first and second side walls 104, 106, and a rear end wall, defined by cross frame members 109, if present, enclose a bulk bag receiving region 110. A bulk bag support surface 112, preferably formed by additional cross frame members of the frame 102 that extend between the first and second side walls 104, 106, bounds a lower portion of the region 110. Alternatively, the support surface 112 can be the floor, or may be a separate structure spaced above the floor, supported by the side walls, the floor, or both the side walls and the floor. The surface 112 is preferably vertically fixed with respect to the frame and may include a turntable mounted for rotation at a central position of the surface 112.

Preferably, two gates 113 are located at the front of the frame 102, each attached to a respective one of the first and second side walls 104, 106. The gates 113 can be moved from an open position, allowing a bulk bag to be placed in bulk bag receiving region 110 for conditioning, and then closed to prevent access during operation of the bulk bag conditioning apparatus 100.

The apparatus 100 is substantially symmetrical about a central parallel plane between the first side wall 104 and the second side wall 106, meaning the construction and function is substantially similar.

Although the description that follows references the first side wall 104, it is appropriate for the second side wall 106 unless the context indicates otherwise.

A first plate 116 is disposed on the first side wall 104 facing the second side wall 106 and supported on a first carriage assembly 118 for vertical displacement between at least a first lower position adjacent to the surface 112 and a first upper position spaced vertically apart from the surface 112 at an upper portion 114 of the first side wall 104. One or more intermediate positions between the first lower position and the first upper position may be provided.

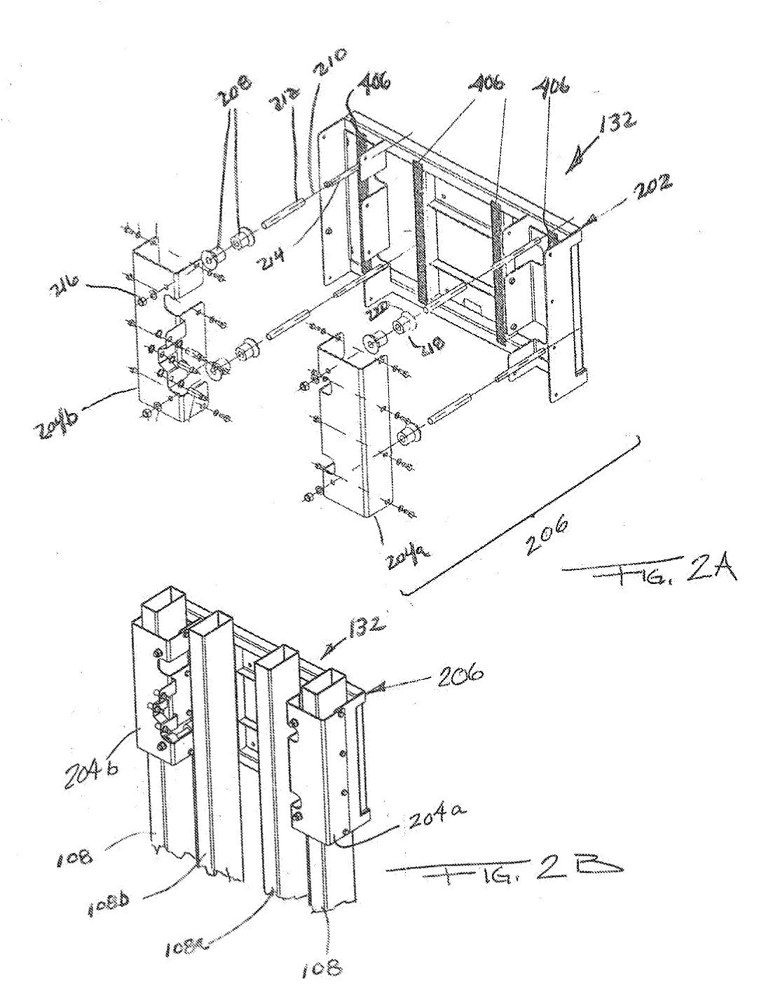

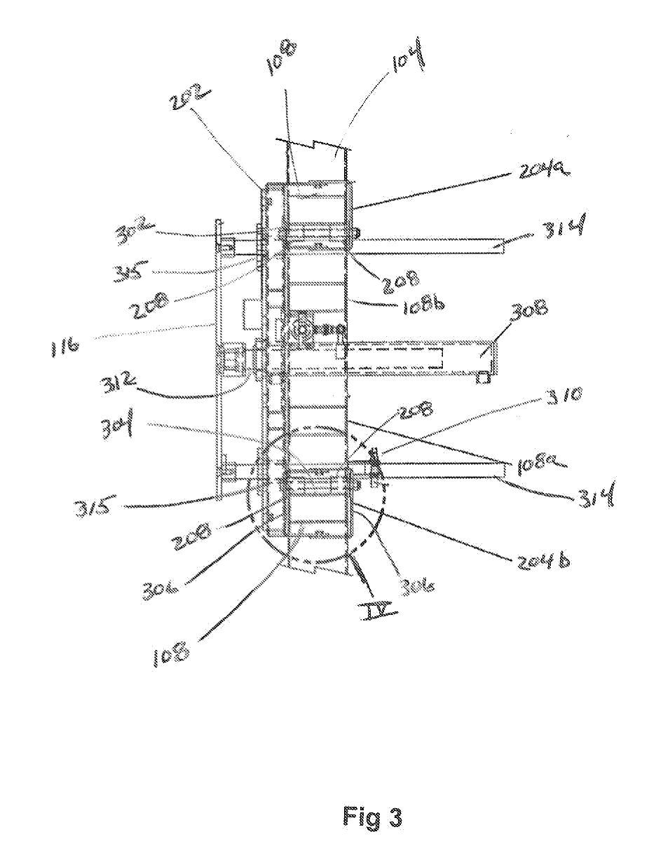

FIG. 2A illustrates a non-limiting embodiment of the second carriage assembly 132 in an exploded view. FIG. 2B is an assembled view of the same second carriage assembly 132 disposed on members 108 of the second side wall 106. The second carriage assembly 132 comprises a housing base 202 and two housing caps 204a, 204b disposed on opposite ends of the housing base 202. Collectively, the housing base 202 and the housing caps 204a, 204b can be referred to as the housing 206. A plurality of contoured rollers 208 (7 shown, 1 is hidden by housing cap 204a), are disposed in pairs between the housing base 202 and each of the housing caps 204a, 204b and supported for rotation about respective longitudinal axes 210 on axles 212 located on respective shafts 214. The shafts 214 are fastened to the housing base 202 and the housing caps 204a, 204b with fastening hardware 216 as shown, or the shaft may be directly fastened to the housing base 202 and housing caps 204a, 204b, such as by welding.

The rollers 208 in the non-limiting embodiment of FIG. 2A have cylindrical bodies 218 with a contoured flange 220 at one end, with the rollers 208 used in pairs on one axle 212. Two pairs of rollers 208 are disposed between the housing base 202 the housing cap 204a with two additional pairs being disposed between the housing base 202 the housing cap 204b. The two pairs of rollers 208 in housing cap 204a are parallel to each other and are parallel to the two pairs of rollers 208 in housing cap 204b.

The rollers 208 need not be the cylindrical body with flanges as illustrated. Each pair of rollers 208 may instead be a single roller having a cylindrical central portion and a contoured flange, similar to contoured flange 220, at either end of the central portion. The single roller will be supported for rotation as illustrated and described for the roller pairs. Other configurations of the rollers 208 may be used within the spirit and scope of the present disclosure.

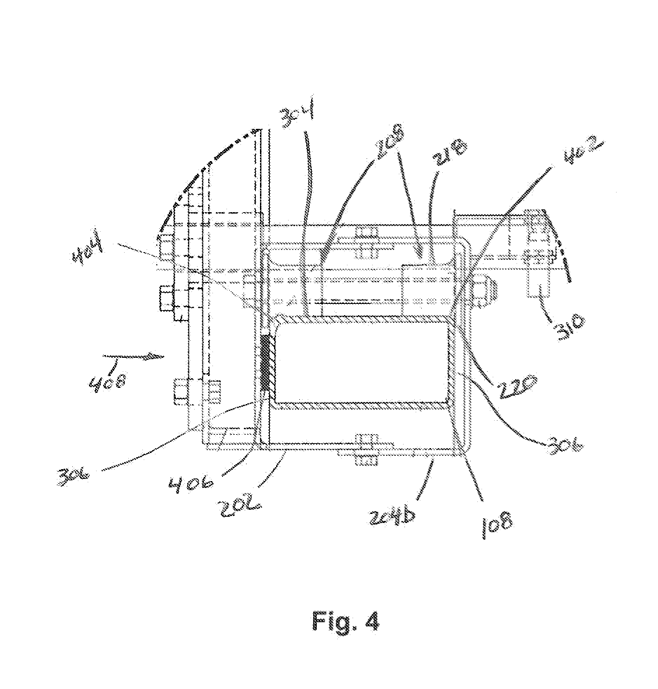

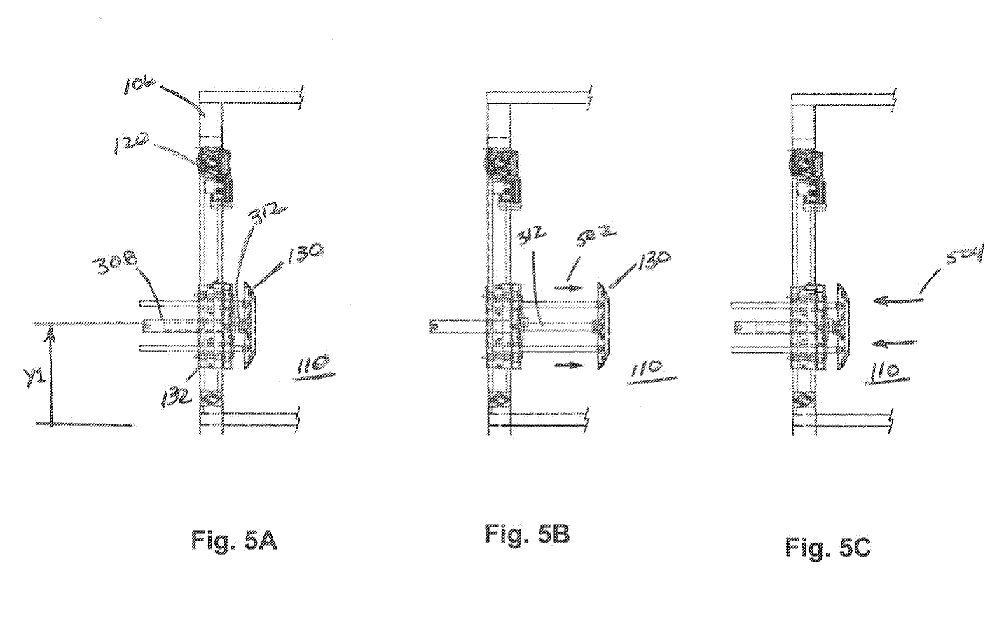

The second carriage assembly 132 is mounted to one or more vertical members having a rectangular cross section. The vertical member may be a component of the frame 102 (the members 108 of the second side wall 106) or may be a separate member. At least some of the rollers 208 cooperate to engage with contours on oppositely facing surfaces 302, 304 of spaced apart members 108 as illustrated in FIGS. 3 and 4. As may be seen in FIG. 4, the cylindrical bodies 218 of the rollers 208 in housing cap 204b abut the surface 304 of member 108. The contoured flanges 220 engage the end surfaces 306 and the contour 402 of the outside corner of the member 108 between the end surfaces 306 and the surface 304.

As shown in FIG. 4, wear strips 406 may be placed on a portion of the housing base 202 adjacent to the end surface 306. The contoured rollers 208 are permitted to move axially (“float”) on the axle 212 and shaft 214 between the housing base 202 and the housing cap 204b. The wear strip 406 has a thickness greater than the thickness of the contoured flange 220 of the roller 208. Thus a lateral force 408 applied to the housing base 202, for example when the actuator 308 is actuated and contacts a bulk bag during bag conditioning, will bring the wear strip 406 into contact with the member 108 and the housing base 202 without compressing the contoured flange 220, allowing free rotation of the roller 208 under a loaded condition of the housing base 202. The float prevents possible damage to the rollers 208 during bag conditioning.

The engagement of the rollers 208 in housing cap 204a at the other end of the housing base 202 is a mirror image of the engagement discussed above and will not be described further.

The members 108 engaged by the rollers 208 in housing caps 204a and 204b may be consecutive vertical members of the first side wall 104 of the frame 102. In the non-limiting embodiment of FIG. 3, the members 108 engaged by the rollers 208 are not consecutive, but have two intervening members 108a and 108b. In other embodiments, one or more intervening vertical members may be disposed between the members 108 engaged by the rollers 208.

Thus configured, the vertical displacement of the first carriage assembly 118 is maintained true and parallel to the members 108. The first plate 116, supported on the carriage, is also displaced true and parallel to the members 108.

The first carriage assembly 118 is linked to a vertical displacement drive 120 to effect vertical displacement of the carriage 118 and the first plate 116. An exemplary vertical displacement drive 120 is shown on the second side wall 106. A second vertical displacement drive 120 is located on the first side wall 104.

The vertical displacement drive 120 includes an energy conversion device to convert an energy input to a force output to displace the first carriage assembly 118. In the non-limiting embodiments illustrated in FIG. 1, the energy conversion device is an electric motor 122, which may be mechanically linked to the first carriage assembly 118 via a gear drive assembly with a sprocket and chain system (not shown). In other embodiments, the energy conversion device may by a pneumatic or hydraulic cylinder linked to the first carriage assembly 118 to effect vertical displacement of the first carriage assembly 118.

A controller 124 is operatively coupled to the electric motor 122 (or pneumatic/hydraulic cylinder) to control the motion of the first carriage assembly 118. Feedback to the controller 124 regarding positioning of the first carriage assembly 118 may be provided by position sensors 310, rotary encoders (not shown) coupled to the output shaft of the electric motor 122, or other feedback devices in communication with the electric motor 122 and the controller 124.

The first carriage assembly 118 also provides support for linear displacement of the first plate 116 within the receiving region 110. The first plate is supported for displacement between a first retracted position with the first plate 116 adjacent to the first wall 104 as shown in FIG. 3 and a first extended position with the first plate 116 extending away from the first side wall 104 into the region 110.

A linear actuator 308, for example hydraulic cylinder, is mounted to the housing base 202 of the first carriage assembly 118 at a position between housing caps 204a, 204b to provide the linear displacement of the first plate 116 into the region 110. An actuator shaft 312 extending from the linear actuator 308 is coupled to the first plate 116 as illustrated in FIG. 3. Guide rods 314 may be provided to guide the first plate 116 in displacement parallel to the first side wall 104. The guide rods 314 are guided in linear bearings 315 mounted on the first and second carriage assemblies 118, 132.

The linear actuator 308 is operatively coupled to the controller 124 which provides signals to the actuator 308 to control extension and retraction of the actuator shaft 312. Extended positioning of the actuator shaft 312 may be controlled by a pressure sensor indicating the first plate has applied a predetermined amount of pressure to an object in its path, such as engaging a bulk bag positioned for conditioning. The extension of the actuator shaft 312 may also be controlled by a position sensor detecting the amount of extension regardless of the amount of pressure exerted up to the limits of the hydraulic circuit. Other systems for determining the position of the actuator shaft 312 may also be employed within the scope of this disclosure.

A second plate 130 (partially hidden in FIG. 1) disposed on the second side wall 106 on a second carriage assembly 132 is similar to first plate 116 in construction, support, and function. The exemplary detailed description above of the first plate 116 and the first carriage assembly 118 pertains to the illustrated embodiment of the second plate 130 and the second carriage assembly 132 which will not be further described.

Although described in terms of first plate 116, the following description pertains to both the first plate 116 and the second plate 130.

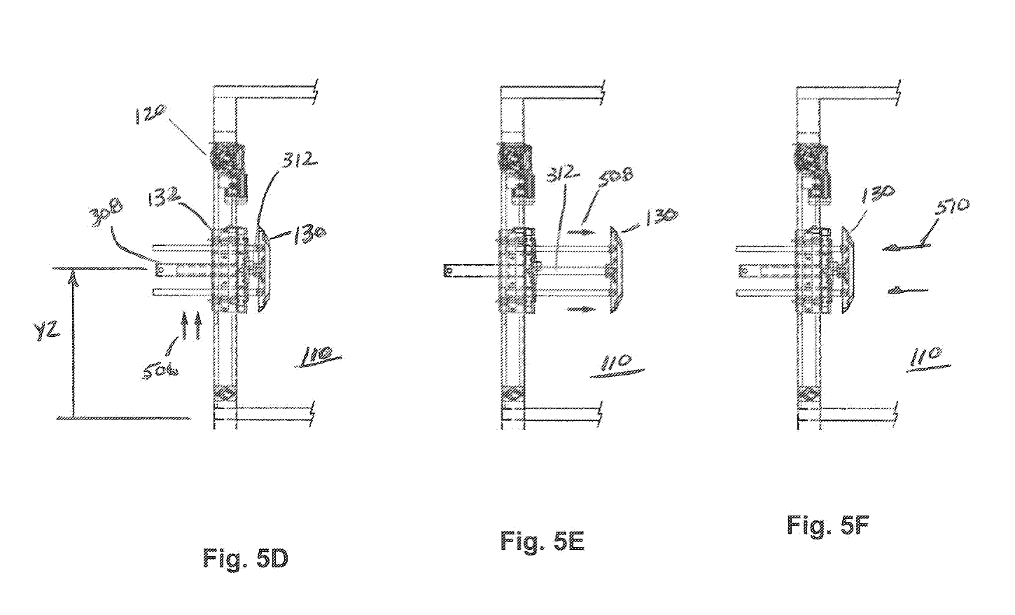

FIGS. 5A-5F are illustrative of a bulk bag conditioner with the second carriage assembly 132 and second plate 130 in various stages for conditioning a bulk bag in accordance with embodiments of the present invention. At FIG. 5A, the second carriage assembly 132 is at a first lower position at Y1 and the actuator shaft 312 of the actuator 308 is in a retracted position corresponding to the first retracted position for second plate 130. Upon a signal from the controller 124, the linear actuator 308 extends the actuator shaft 312 in the direction of the arrows 502 to an extended position corresponding to the first extended position of the second plate 130 as shown in FIG. 5B. In the extended position of FIG. 5B, the second plate 130 is extended sufficiently to engage a bulk bag in the region 110. After extending to predetermined pressure or distance condition, the controller 124 signals the linear actuator 308 to retract the actuator shaft 312 in the direction of arrows 504. The second plate 130 may retract to the first retracted position of 5A or may retract to a different position. The sequence of the actuator shaft 312 from a retracted position to an extended position to a retracted position, illustrated in 5A through 5C, represents an illustrative conditioning cycle with the second carriage assembly 132 at Y1. Other conditioning cycle steps may include additional intermediate positions between those represented at 5A and 5C. Any conditioning cycle may be repeated a predetermined number of times or for a predetermined period of time.

Upon completion of a prescribed number of cycles in the first lower position of FIGS. 5A-5C, the controller 124 signals the vertical displacement unit 120 to index the second carriage assembly 132 in the direction of arrows 506 to a vertical position Y2 corresponding to the first upper position of second plate 130. At 5D, the second carriage assembly 132 is at a first upper position at Y2 and the actuator shaft 312 is in a retracted position corresponding to the first retracted position for second plate 130. Upon a signal from the controller 124, the linear actuator 308 extends the actuator shaft 312 in the direction of the arrows 508 to an extended position corresponding to the first extended position of the second plate 130 as shown in FIG. 5E. In the extended position of FIG. 5E, the second plate 130 is extended sufficiently to engage a bulk bag in the region 110. After extending to predetermined pressure or distance condition, the controller 124 signals the linear actuator 308 to retract the actuator shaft 312 in the direction of arrows 510. The second plate 130 may retract to the first retracted position of 5A or may retract to a different position. The sequence from 5D to 5F represents, as above, an illustrative conditioning cycle with the second carriage assembly 132 at Y2. Other conditioning cycles may include additional intermediate positions between those represented in 5D through 5F. Any conditioning cycle may be repeated for a predetermined number of times or for a predetermined period of time.

The carriage may be vertically displaced to an optional intermediate position Y3 between Y1 and Y2 where the actuator shaft 312 may cycle through steps similar to 5A-5C or 5D-5F.

The cycling at positions Y1, Y2, and Y3 may occur in any order.

The first plate 116 performs conditioning cycles similar to those represented by FIGS. 5A-5C and 5D-5F, independent of the position of the second plate 130. In some embodiments, the cycle steps for the second plate 130 may correspond to those of the first plate 116. That is, the second plate 130 mounted to the second carriage assembly 132 at the same or similar vertical position as the first plate 116 may extend while the first plate 116 is extending and the second plate 130 may retract while the first plate is retracting. That is, the first plate 116 may move as a mirror image of the second plate 130.

In other embodiments, the first plate 116 may extend while the second plate 130 is retracting (i.e., sequentially) and vice versa. In another embodiment, the first plate 116 may be extending and retracting at one vertical position and the second plate 130 may be extending and retraction (or retracting and extending) at another vertical position. Any overlap of vertical position of the first carriage assembly 118 and the second carriage assembly 132, and condition of extension and retraction of the first and second plates 116, 130 may be employed in accordance with this disclosure.

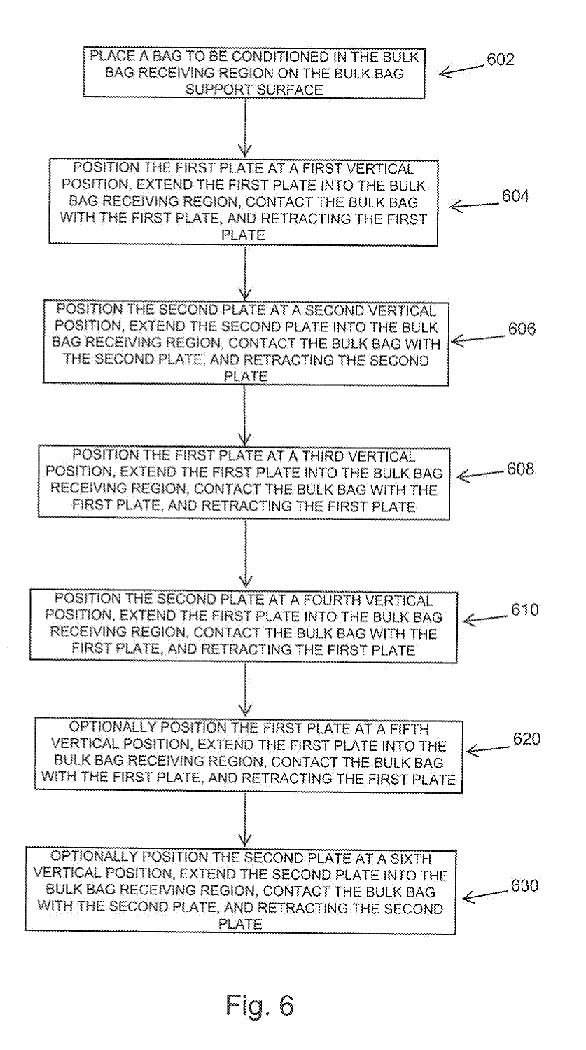

A method for conditioning a bulk bag in a bulk bag apparatus in accordance with embodiments of this invention is illustrated at FIG. 6. At 602, a bulk bag to be conditioned is placed in the bulk bag receiving region, region 110, on the bulk bag support surface, surface 112.

At 604, with the first plate 116 positioned at a first vertical position by vertically displacing the first carriage assembly 118 at the corresponding vertical location, the first plate 116 extends into region 110, contacts the bulk bag and retracts.

At 606, which may occur before, after, or contemporaneously with 604, the second plate 130 is positioned on the second carriage assembly 132 at a second vertical position, which may or may not correspond with the first vertical position. The second plate 130 is extended into the region 110, contacts the bulk bag, and retracts.

At 608 with the first plate 116 positioned at a third vertical position by vertically displacing the first carriage assembly 118 to the corresponding vertical location, the first plate 116 extends into the region 110, contacts the bulk bag and retracts.

At 610, which may occur before, after, or contemporaneously with 608, the second plate 130 is positioned on the second carriage assembly 132 at a fourth vertical position, which may or may not correspond with the third vertical position. The second plate 130 is extended into the region 110, contacts the bulk bag, and retracts.

At 620, the first plate 116 is optionally positioned at a fifth vertical position by vertically displacing the first carriage assembly 118 to the corresponding vertical location, the first plate 116 extends into the region 110, contacts the bulk bag and retracts. The fifth vertical position may be an intermediate position between the first position and the third position or may be beyond the first or third positions.

At 620, the second plate 130 is optionally positioned at a sixth vertical position by vertically displacing the second carriage assembly 132 to the corresponding vertical location. The second plate 130 extends into the region 110, contacts the bulk bag and retracts. The sixth vertical position may be an intermediate position between the second position and the fourth position or may be beyond the second or fourth positions.

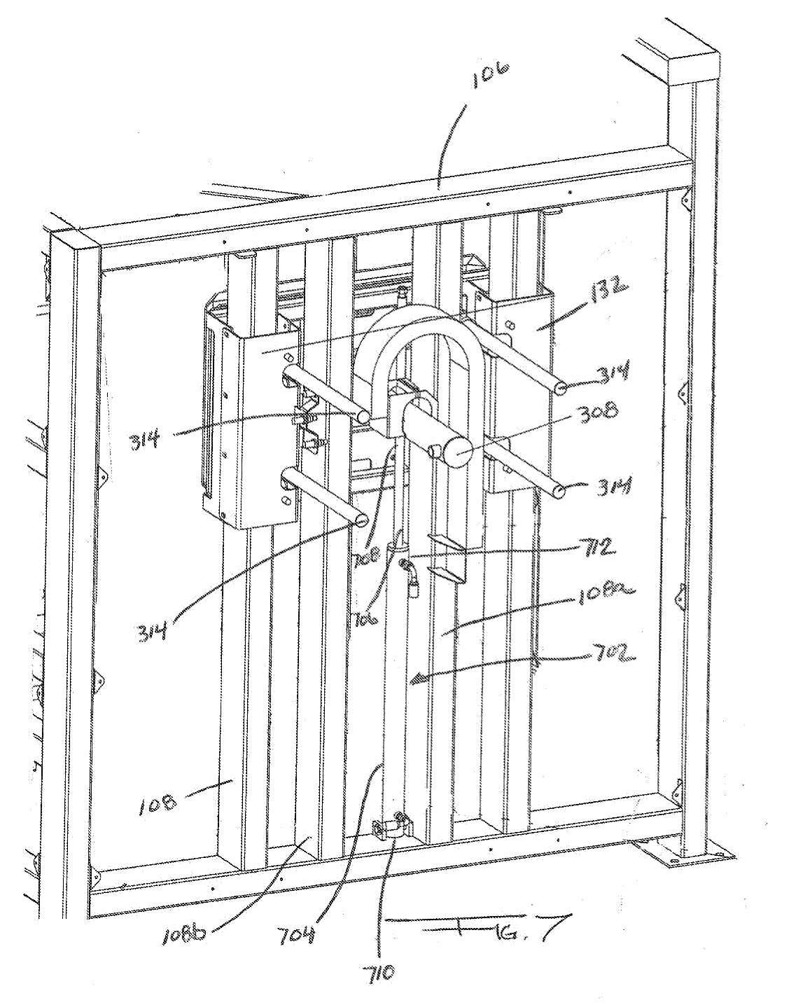

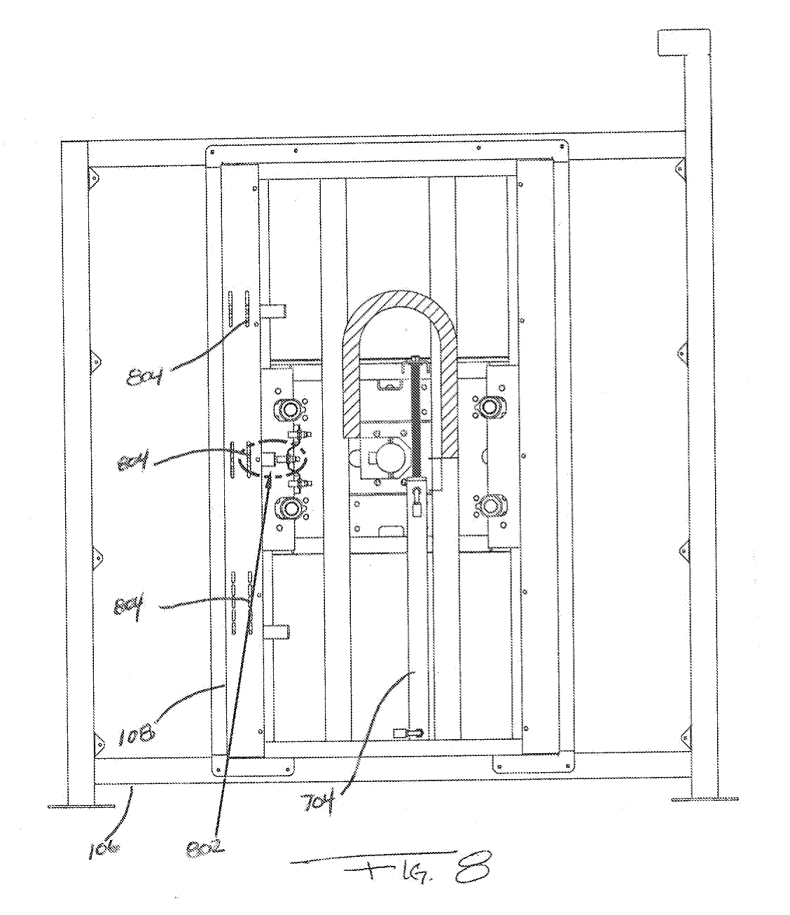

Referring to FIGS. 7 and 8, an alternate drive for raising and lowering the second carriage assembly 132 is shown on exemplary second side wall 106 of the apparatus 100. The second side (not shown) is similarly equipped.

In the non-limiting embodiment, the valve body 704 of an hydraulic actuator 702 is coupled to a portion of the frame, for example a lower horizontal crosspiece. The end 708 of the cylinder rod 706 is coupled to the second carriage assembly 132. The hydraulic actuator 702 is preferably a double acting cylinder as illustrated. The hydraulic actuator 702 is fluidly coupled to a controlled source of pressurized fluid (not shown) at a lower end 710 and an upper end 712 of the valve body. The controller 124 controls the flow of pressurized fluid to the lower end 710 to extend the cylinder rod 706, thereby raising the second carriage assembly 132 or to the upper end 712 to retract the cylinder rod 706 and lower the second carriage assembly 132.

A vertical position sensor, for example a proximity switch 802, is mounted on the second carriage assembly 132 and in communication with the controller 124. The proximity switch 802 detects preferred vertical positions of the second carriage assembly 132 by detecting targets 804 (three shown) on a fixed vertical member 108 of the second side wall 106. A signal is sent from the proximity switch 802 to the controller 124 when the target 804 is detected. Pressurized fluid flow to the cylinder 704 is changed by the controller 124 in response to the signal received from the proximity switch 802.

Thus, embodiments of an apparatus and method for conditioning a bulk bag that may provide beneficial results in conditioning the contents of a bulk bag are provided herein.

While the foregoing is directed to embodiments of the present invention, other and further embodiments of the invention may be devised without departing from the basic scope thereof

What is claimed is:

1. An apparatus for conditioning a bulk bag, comprising:
a frame including a first side wall and an opposing second side wall enclosing a bulk bag receiving region;
a bulk bag support surface within the bulk bag receiving region fixed against vertical displacement with respect to the frame;
a first plate disposed on the first side wall supported for vertical displacement between a first lower position adjacent to the bulk bag support surface and a first upper position spaced apart from the bulk bag support surface and further supported for linear displacement within the bulk bag receiving region between a first retracted position adjacent the first side wall and a first extended position; and
a second plate disposed on the second side wall supported for vertical displacement between a second lower position adjacent to the bulk bag support surface and a second upper position spaced apart from the bulk bag support surface and further supported for linear displacement within the bulk bag receiving region between a second retracted position adjacent the second side wall and a second extended position.

2. The apparatus of claim 1, wherein a displacement of first plate between the first retracted position and the first extended position is independent of a displacement of the second plate between the second retracted position and the second extended position.

3. The apparatus of claim 1, wherein the displacement of the first plate between the first lower position and the first upper position is independent from the displacement of the second plate between the second lower position and the second upper position.

4. The apparatus of claim 1, wherein the first plate is further supported for vertical displacement to a first intermediate position between the first lower position and the first upper position.

5. The apparatus of claim 1, wherein the second plate is further supported for vertical displacement to a second intermediate position between the second lower position and the second upper position.

6. The apparatus of claim 1, wherein the first lower position and the second lower position are equally spaced from the bulk bag support surface.

7. The apparatus of claim 1, wherein the first upper position and the second upper position are equally spaced from the bulk bag support surface.

8. The apparatus of claim 1, further comprising:
a first carriage assembly mounted to the first side wall for vertical displacement between a lower position corresponding to the first lower position and an upper position corresponding to the first upper position,
wherein the first carriage assembly comprises a housing and a plurality of contoured rollers mounted to the housing and supported for rotation about a longitudinal axis so that at least some of the rollers cooperate to follow a contour of a vertical member on the frame.

9. The apparatus of claim 8, wherein the vertical member has a rectangular cross section having corners so that the contoured rollers engage at least some of the corners of the vertical member for guiding the carriage.

10. The apparatus of claim 8, wherein the carriage is linked to a vertical displacement unit for controlling the displacement between the lower position and the upper position.

11. The apparatus of claim 10, wherein the vertical displacement unit comprises a gear drive assembly driven by an electric motor and position sensors in communication with the electric motor.

12. The apparatus of claim 8, further comprising a linear actuator mounted to the carriage and coupled to the first plate, wherein the linear actuator is extendable between a first length corresponding to the first retracted position and a second length corresponding to the first extended position.

13. The apparatus of claim 12, wherein the linear actuator is a hydraulic cylinder.

14. The apparatus of claim 12, further comprising a plurality of guide rods mounted to the first plate and arranged parallel to the linear actuator, and linear bearings mounted to the carriage, the guide rods extending through the linear bearings.

15. The apparatus of claim 8, further comprising:
a second carriage assembly mounted to the second side wall for vertical displacement between a lower position corresponding to the second lower position and an upper position corresponding to the second upper position,
wherein the second carriage assembly comprises a housing and a plurality of contoured rollers mounted to the housing and supported for rotation about a longitudinal axis so that at least some of the rollers cooperate to follow a contour of a vertical member on the second side wall of the frame.

16. In a bulk bag conditioning apparatus according to claim 1, a method for conditioning a bulk bag comprising:
(1) placing a bulk bag to be conditioned in the bulk bag receiving region on the bulk bag support surface;
(2) positioning the first plate at a first vertical position, extending the first plate into the bulk bag receiving region, contacting the bulk bag with the first plate, and retracting the first plate;
(3) positioning the second plate at a second vertical position, extending the second plate into the bulk bag receiving region, contacting the bulk bag with the second plate, and retracting the second plate;
(4) positioning the first plate at a third vertical position, contacting the bulk bag with the first plate by extending the first plate into the bulk bag receiving region, and retracting the first plate; and
(5) positioning the second plate at a fourth vertical position, contacting the bulk bag with the second plate by extending the second plate into the bulk bag receiving region and retracting the second plate.

17. The method of claim 15, wherein steps (2) and (3) occur contemporaneously.

18. The method of claim 15, wherein steps (4) and (5) occur contemporaneously.

19. The method of claim 15, wherein steps (2) and (3) occur sequentially.

20. The method of claim 15, wherein steps (4) and (5) occur sequentially.

21. The method of claim 15, wherein a cycle of steps (2), (3), (4), and (5) are repeated for a predetermined number of times.
